(19) United States
(12) Patent Application Publication
(10) Pub. No.: US 2002/0122954 A1
(43) Pub. Date: Sep. 5, 2002

(54) Composite structural panel

(76) Inventor: Habib J. Dagher, Veazie, ME (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/085,375

(22) Filed: Feb. 28, 2002

Related U.S. Application Data
(62) Division of application No. 09/374,910, filed on Aug. 13, 1999.

(51) Int. Cl. B32B 23/04

(52) U.S. Cl. 428/537.1; 427/369; 428/438; 428/425.1; 428/528; 428/541

(57) ABSTRACT

A Composite Structural Panel (CSP) includes a composite core that is preferably made of a plurality of vertically laminated Oriented Strand Board (OSB) sheets. The OSB sheets may be fastened together by using any conventional fastening means, such as an adhesive. Preferably, the CSP also includes a layer of polymer concrete applied to the top surface of the composite core, and a layer of glass fiber reinforced polymer (GFRP) reinforcement material having E-glass fibers applied to the bottom surface of the composite core. When the CSP is supported directly on the ground, the E-glass fibers of the GFRP reinforcement material are preferably oriented in a transverse direction with respect to the plurality of vertically laminated OSB sheets. A layer of protective material may be applied to the side surfaces of the composite core to provide additional protection from harsh environmental conditions. Other core configurations include a plurality of sheets of glue-laminated solid-sawn lumber, a sub-core laminated with a uni-directional and bi-directional sub-skin, and a sub-core laminated with a single or multiple sub-skin sheet. The CSP may be designed for a wide variety of applications, such as a road panel, a crane mat, a bridge deck, a soldier pile, and the like.

### BACKGROUND OF THE INVENTION

This invention relates in general to panels, and in particular, to a Composite Structural Panel (CSP) with a composite core preferably made of an Oriented Strand Board (OSB) material.

The construction industry utilizes solid sawn wood and wood panel members in a variety of forms to aid in the erection of buildings, roads and bridges. For example, temporary road panels and crane mats are often constructed using solid-sawn hardwood timbers or some species of softwoods. These panels are used to form a temporary lightweight roadway or foundation to facilitate vehicular and equipment travel as may be required in construction operations.

As shown in FIG. 1, a conventional road panel, shown generally at 10, is formed by using a plurality of solid sawn timber 12. Typically, four pieces of solid sawn timber 12 are used, each having a dimension of 1′×1′×16′. The four pieces of timber 12 are usually bolted together using bolts 14 to form the temporary road panel 10 having an assembled dimension of 4′×1′×16′. Several panels are placed side by side over existing ground to form a temporary roadway or to support cranes on a construction site. Ground conditions under the panels vary greatly and may include, for example, sand, clay, wetlands and possibly a considerable amount of water.

The hardwood panels are typically discarded at the end of the construction project, or they may be re-used if they are in relatively good condition. The longevity of the panels may be as little as six months to one year, depending on the length of the construction project and the environmental conditions to which the panels are subjected. The wood panels are typically untreated with preservative chemicals because of environmental concerns. Hardwoods are typically-used because of their superior wear resistance to heavy truck and other construction equipment traffic. In addition to road panels and crane mats, other applications for the hardwood panels include decks over steel girders for temporary bridges, and soldier piles.

Because the timber used to form the panel 10 is expensive, the panel 10 is very costly. Further, the roadway formed by the panels 10 is very costly because tens of thousands of the panels 10 may be used for a single construction project. In addition, the solid sawn timber used to form the panel 10 is scarce because of the solid sawn timber must be extremely long, typically about sixteen feet in length. Therefore, it would be desirable to provide a cost effective panel made of a relatively inexpensive and readily available material that has sufficient strength and durability to replace the existing solid sawn timber panels.

### SUMMARY OF THE INVENTION

This invention relates to a cost effective panel design that replaces the existing solid sawn timber panels. According to the invention, a Composite Structural Panel comprises a composite core comprising a plurality of sheets made of a composite material, the plurality of sheets being oriented parallel to a direction of an applied load.

A method of manufacturing the Composite Structural Panel comprises the step of forming a composite core comprising a plurality of sheets made of a composite material, the plurality of sheets being oriented parallel to a direction of an applied load.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is side perspective view of a conventional road panel formed of solid sawn timber;

FIG. 2 is a cutaway side perspective view of a portion of a horizontally laminated Oriented Strand Board test beam;

FIG. 3 is a cutaway side perspective view of a portion of a vertically laminated Oriented Strand Board test beam;

FIG. 4 is a side perspective view of the basic components of a Composite Structural Panel according to a preferred embodiment of the invention;

FIG. 5 is a side perspective view of a preferred embodiment of a Composite Structural Panel comprising a plurality of vertically laminated sheets oriented parallel to the applied load for construction applications, such as a road panel, in which the Composite Structural Panel is supported directly on the ground;

FIG. 6 is a side perspective view of a preferred embodiment of a Composite o Structural Panel for construction applications, such as a bridge deck, in which the Composite Structural Panel is supported above the ground;

FIG. 7 is a side elevational view of the Composite Structural Panel shown in FIG. 5;

FIG. 8 is a side perspective view of a preferred embodiment of a Composite Structural Panel for construction applications, such as a soldier pile, in which the Composite Structural Panels are placed side-by-side in a vertical arrangement;

FIG. 8a is a cross sectional view of a tongue and groove arrangement for connecting adjacent Composite Structural Panels;

FIG. 9 is a side perspective view of a preferred embodiment of the invention in which the Composite Structural Panel comprises a plurality of horizontally laminated sheets oriented perpendicular to the applied load;

FIG. 10 is a side perspective view of a preferred embodiment of the invention in which a core of a Composite Structure Panel includes a plurality of vertically-laminated solid-sawn lumber;

FIG. 11 is a side perspective view of a preferred embodiment of the invention in which a core of a Composite Structure Panel includes a unidirectional sub-skin laminated onto one or more wide faces of a sub-core;

FIG. 12 is a side perspective view of a preferred embodiment of the invention in which a core of a Composite Structure Panel includes a bi-directional sub-skin laminated onto one or more wide faces of a sub-core; and

FIG. 13 is a side perspective view of a preferred embodiment of the invention in which a core of a Composite Structure Panel includes a single or multiple sub-skin laminated onto one or more wide faces of a sub-core.

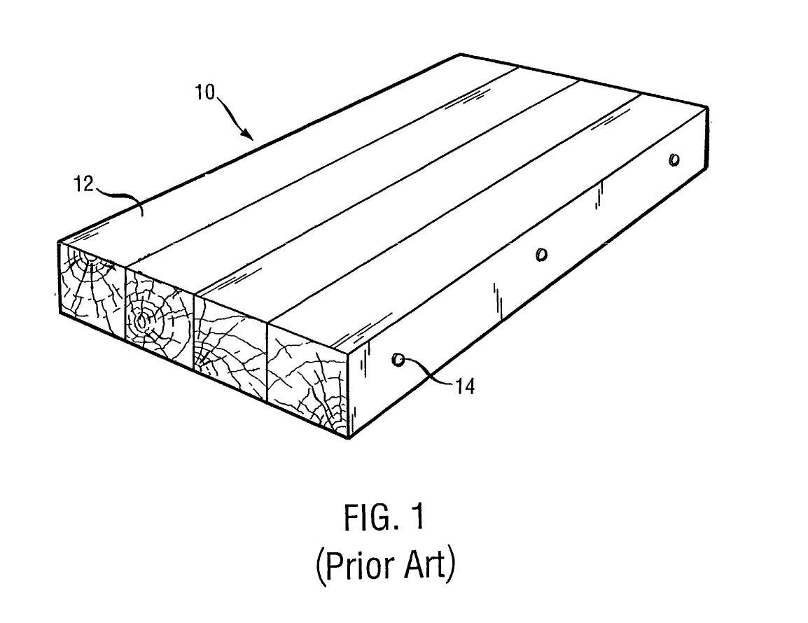

### DETAILED DESCRIPTION OF THE PREFERRED EMBODIMENT

Engineering, laboratory and field testing was conducted to determine whether a composite structural panel (CSP) with a core made of inexpensive wood material, such as Oriented Strand Board (OSB), can be made to rival the strength and durability of bolted solid-sawn timbers. For clarity of presentation, the remaining part of this description focuses on cores made with OSB sheets, but plywood sheets and billets of LVL (Laminated Veneer Lumber), PSL (Parallel Strand Lumber), Glulam (Glued Laminated Timber), OSL (Oriented Strand Lumber) and other SCL (Structural Composite Lumber) can be substituted for the composite core material.

OSB is an engineered structural use panel manufactured from thin wood strands bonded together with waterproof resin under heat and pressure. OSB sheets are typically used in residential or commercial construction for roof or floor sheathing and offer a less expensive alternative to plywood. OSB has good bending and shear strength for those applications. Also, OSB has good durability if used in sheltered or covered environments where it is not subjected to direct exposure to the elements. When OSB is exposed to direct water for extended periods of time, its mechanical strength and stiffness are significantly reduced, and its dimensional stability is compromised. Industry practice is that OSB should not be used in exposed environments. Also, OSB is not intended for and has not been used as the main structural member to support loads from heavy trucks, cranes, and other vehicles, let alone when it is exposed to the elements.

Although the CSP can be designed for any application, laboratory studies were conducted on the horizontally and vertically laminated beams to test whether the beams can support all static, impact, and fatigue loads anticipated during use as a temporary road panel, for example, during the construction of a pipeline. To this end, the beams were expected to perform under a variety of dry and wet conditions. A safety factor was used for the beams so that the beams can withstand worst-case static loading without excessive deflection. The safety factor was necessary to account for impact and fatigue conditions because the beams were not tested under fatigue conditions. However, it is expected that the safety factors provide adequate protection against fatigue during the lifetime of the beams.

During pipeline construction, all types of vehicles, for example, heavy machinery, pickup trucks, dump trucks, excavators, and pipelayers, may traverse the CSP. Using equipment dimensions and weights available from equipment manufacturers, it was determined that a pipelayer Model 578, available from Cianbro, presented the worst load case.

The traffic pattern across the panel was a major design parameter. For maximum transverse stresses, the pipelayer was oriented in the longitudinal direction with its track centered on the test bears. For maximum bending, as well as shear longitudinal stress, the pipelayer was oriented in the transverse direction with one track centered on the test beams and the other track supported directly by the soil adjacent to the test beams.

The test beams were modeled as a beam with uniform upward soil pressure in both the transverse and longitudinal directions. This model leads to conservative estimates of applied stresses. The maximum applied stresses for all load scenarios involving the pipelayer is given in Table 1 below.

TABLE 1
Maximum Applied Stress with the Pipelayer

| | |
|---|---|
| LONGITUDINAL | TRANSVERSE |

| Bending | Shear | Bending | Shear |
|---|---|---|---|
| 2290 psi | 143 psi | 94 psi | 24 psi |

A variety of static tests were performed to determine the mechanical properties of various test beams in both the longitudinal and transverse directions. One test beam was initially tested to obtain a general idea of the strength of the material in three-point bending (horizontal layup) (Test I). Nine beams were then fabricated and tested to determine shear and bending strength in both horizontal and vertical laminated directions. Once it was determined that the vertical layup was superior, twelve beams were fabricated and tested in three-point bending. Two of these beams were tested without any reinforcement, and ten of the beams were given 1% reinforcement (by volume) to increase the bending strength in the transverse direction. These ten reinforced beams had the reinforcement applied at different clamping pressures to determine whether the standard pressure (80 psi) would be satisfactory.

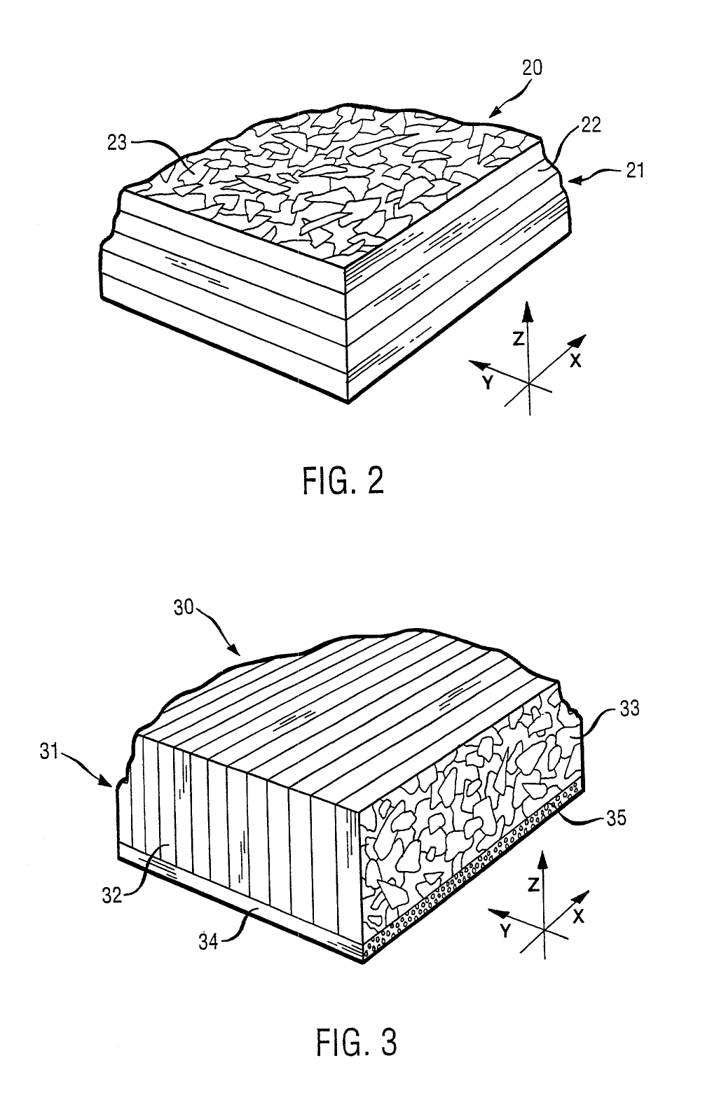

FIG. 2 shows a cutaway view of a horizontally laminated test beam, shown generally at 20. The beam 20 comprises a core 21 formed by a plurality of horizontally stacked OSB sheets 22. The longitudinal or x-direction is parallel to the wide faces of the OSB sheets 22, and to the plane of the flakes 23 of the OSB sheets 22. The transverse or y-direction is parallel to the wide faces of the OSB sheets 22, and to the plane of the flakes 23 of the OSB sheets 22. The axial or z-direction is perpendicular to the wide faces of the OSB sheets 22, and to the plane of the flakes 23 of the OSB sheets 22.

Testing of both large and small size beams was conducted using the beam 20 in order to determine the bending and shear strength of the beam 20 when loading is applied in the axial or z-direction. Specifically, three tests (Tests I, II and III) were conducted for six large beams. The results from the tests were compared to the maximum applied stresses and strength properties of the beam 20. The results indicated that the beam 20 could not support longitudinal rolling shear and that the safety factor for longitudinal bending was insufficient. Each test is described and the results are given below.

TEST I: Initial Test 1 Beam, 8.5″×8″×8′ to Estimate Strength

Specimen Description:

1 beam, 8.5″×8″×8′

¾″ horizontally laminated OSB sheets

adhesive: GP PRF 4242/4554

adhesive spread rate=90 lbs per 1000 sq. ft. of joint

clamping pressure=80 psi

cure: room temperature

Test Setup:

three-point bending with a span length of 7′

tested with a Baldwin Universal Testing Machine (UTM)

Results:

beam failed in tension

bending stress at failure=2.17 ksi

shear stress at failure=103 psi

Modulus of Elasticity (MOE)=0.39×10⁶ psi

TEST II: Horizontal Layup 2 Beams, 3.5″×7.5″×12′

Specimen Description:

2 beams, each approximately 3.5″×7.5″×12′

¾″ horizontally laminated OSB sheets

adhesive: GP PRF 4242/4554

adhesive spread rate=90 lbs per 1000 sq. ft. of joint

clamping pressure=80 psi

cure: room temperature

Test Setup:

four-point bending with a span length of 11′

tested in a MTS assembly

Results:

tension failures in both beams

| | Bending Stress at Failure | Shear Stress at Failure |
|---|---|---|
| Sample | (ksi) | (psi) |
| 1 | 2.55 | 100 |
| 2 | 2.09 | 82 |

TEST III: Horizontal Layup 3 Beams, 3.5″×7.5″×4′

Specimen Description:

3 beams, each approximately 3.5″×7.5″×4′

¾″ horizontally laminated OSB sheets

adhesive: GP PRF 4242/4554

adhesive spread rate=90 lbs per 1000 sq. ft. of joint

clamping pressure=80 psi

cure: room temperature

Test Setup:

three-point bending with a span length of 30″

tested in Instron

Results:

shear failures in all three beams

| | Bending Stress at Failure | Shear Stress at Failure |
|---|---|---|
| Sample | (ksi) | (psi) |
| 1 | 1.601 | 198 |
| 2 | 1.877 | 233 |
| 3 | 1.615 | 200 |

In summary, the results of the testing of the panel 20 was that the panel 20 failed all the tests.

FIG. 3 shows a cutaway view of a vertically laminated test beam, shown generally at 30. The beam 30 comprises a core 31 formed by a plurality of vertically stacked OSB sheets 32. The longitudinal or x-direction is parallel to the wide faces of the OSB sheets 32, and to the plane of the flakes 33 of the OSB sheets 32. The transverse or y-direction is perpendicular to the wide faces of the OSB sheets 32, and to the plane of the flakes 33 of the OSB sheets 32. The axial or z-direction is parallel to the wide faces of the OSB sheets 32, and to the plane of the flakes 33 of the OSB sheets 32.

Testing of both large and small beams was also conducted to evaluate both the longitudinal shear and bending strengths of the beam 30 when loading was applied in the axial or z-direction. Specifically, one test (Test IV) was conducted for three small beams, another test (Test V) was conducted for three small beams with variable length, and one test (Test VI) was conducted for twelve beams, with ten of the twelve beams having a coating 34 of unidirectional glass fiber reinforced polymer (GFRP) to provide increased tensile strength on the bottom side of the test beam 30, with the glass fibers 35 oriented in the transverse or y-direction. The ten reinforced beams had the reinforcement 34 applied at three different clamping pressures (0, 5 and 80 lbs/in²) to determine whether the standard clamping pressure (80 lbs/in²) is satisfactory. The results of Tests IV and V indicated that both longitudinal bending and shear strength was increased in the vertically laminated test beam 30, when compared to the horizontally laminated test beam 20. Further, the results of Test VI indicated that the GFRP reinforcement 34 increased transverse bending strength by at least a factor of forty, thereby correcting any anticipated loss of transverse bending strength. Each test is described and the results are given below.

TEST IV: Vertical Layup 3 Beams, 7.5″×3.5″×4′

Specimen Description:

3 beams, each approximately 7.5″×3.5″×4′

¾″ vertically laminated OSB sheets

adhesive: GP PRF 4242/4554

adhesive spread rate=90 lbs per 1000 sq. ft. of joint

clamping pressure=80 psi

cure: room temperature

Test Setup:

three-point bending with a span length of 30″

tested in UTM

Results:

tension failures in all three beams; these failures were unexpected because of shear strengths that were higher than anticipated

| | Bending Stress at Failure | Shear Stress at Failure |
|---|---|---|
| Sample | (ksi) | (psi) |
| 1 | 3.84 | 236 |
| 2 | 3.40 | 212 |
| 3 | 3.32 | 209 |

TEST V: Vertical Layup 3 Beams, 7.5″×3.5″

Cross-Section with Variable Length

Specimen Description:

3 beams, each approximately 7.5″×3.5″×variable length

tested with variable span length

¾″ vertically laminated OSB sheets

adhesive: GP PRF 424214554

adhesive spread rate=90 lbs per 1000 sq. ft. of joint

clamping pressure=80 psi

cure: room temperature

Test Setup:

three-point bending with variable span length

tested in UTM

Results:

tension failures in all three beams

| | Span Length | Bending Stress at Failure | Shear Stress at Failure |
|---|---|---|---|
| Sample | (in) | (ksi) | (psi) |
| 1 | 20 | 3.54 | 318 |
| 2 | 12 | 3.41 | 511 |
| 3 | 12 | 3.38 | 508 |

TEST VI: Vertical Layup 12 Beams, 7.5″×3.5″×2′

Transverse Bending

Specimen Description:

12 beams, each approximately 7.5″×3.5″×2′

tested with variable span length

¾″ vertically laminated OSB sheets

adhesive: GP PRF 4242/4554

adhesive spread rate=90 lbs per 1000 sq. ft. of joint

clamping pressure=80 psi

cure: room temperature

reinforced beams contain 1% GFRP by volume (one layer 18 oz. unidirectional weave)

cured thickness of GFRP=1%

depth of wood

a wetpreg layup was used with a 1:1 weight ratio of wet resin to glass

clamping pressures of reinforcement variable: 0 psi, 5 psi, 80 psi

Test Setup:

three-point bending with variable span length

tested in UTM

Results:

tension failures in all three beams

| | | | Bending Stress | | | |
|---|---|---|---|---|---|---|
| | | Clamp | at Failure | | Shear Stress at Failure | |
| | | Pressure | (ksi) | | (psi) | |
| Group | Sample | (psi) | Gross | Transform | Gross | Transform |

| | | | | | | |
|---|---|---|---|---|---|---|
| Control | 1 | — | 0.112 | 0.112 | 10.8 | 11 |
| | 2 | — | 0.091 | 0.091 | 8.7 | 9 |
| | 1 | 80 | 1.29 | 1.29 | 123 | 114 |
| | 2 | 80 | 2.03 | 0.93 | 196 | 183 |
| | 3 | 80 | 1.57 | 1.47 | 151 | 141 |
| | 4 | 80 | 1.84 | 1.15 | 179 | 167 |
| | 5 | 80 | 1.75 | 1.34 | 167 | 156 |
| | 6 | 80 | 1.75 | 1.27 | 183 | 171 |
| | 7 | 0 | 2.43 | 1.87 | 231 | 230 |
| | 8 | 0 | 2.36 | 1.71 | 226 | 211 |
| | 9 | 5 | 2.19 | 1.60 | 219 | 204 |
| | 10 | 5 | 2.02 | 1.45 | 189 | 176 |

In summary, the results of the testing indicated that the OSB beam 30 can support all static, impact, and fatigue loads anticipated during use when the OSB beam 30 is directly supported by the ground, such as during use as a road panel, crane mat, and the like.

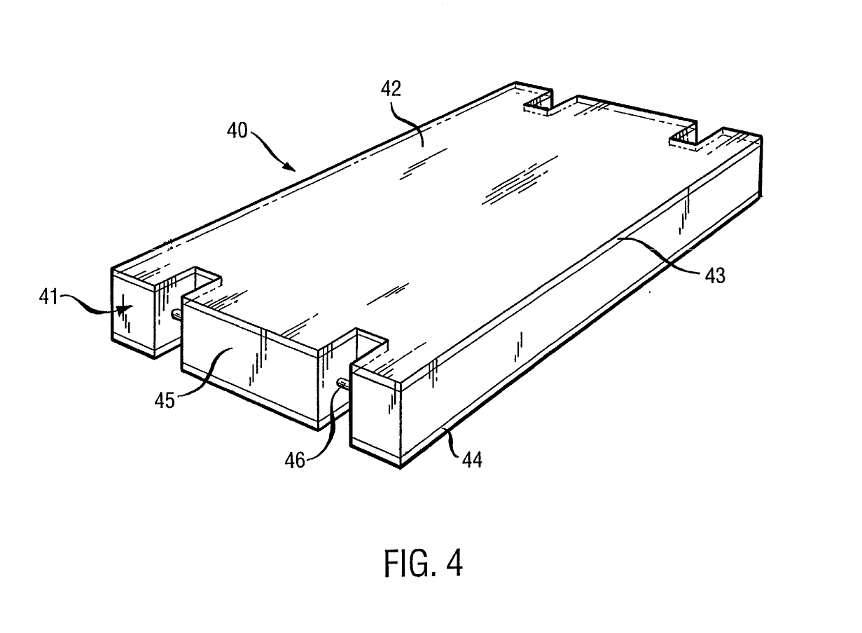

Referring now to the drawings, there is illustrated in FIG. 4, the basic components for a Composite Structural Panel (CSP), shown generally at 40, according to a preferred embodiment of the invention. The basic components for the CSP 40 comprises a core 41, a wearing surface 42, a layer of synthetic fiber reinforcement 43 on one or both side faces, an optional moisture resistant treatment 44 on one or both wide faces and side faces of the CSP 40, an optional decay-resistant treatment 45 on one or more of wide faces and side faces of the CSP 40, and at least one optional lifting/handling/connection device 46 to allow the CSP 40 to be easily lifted or connected to another Composite Structural Panel as may be necessary in a construction environment.

For construction applications supported directly on the ground, the CSP 40 supports construction vehicles, such as trucks, front-end loaders, and the like, as well as, construction equipment loading, such as cranes, and the like, and transmits the loading to the ground below. As a result, the CSP 40 is subjected to bending and shear stresses in both the transverse and longitudinal directions, bearing stresses under the wheel or track loading, stress concentrations along the four top sides caused by vehicle traffic climbing on and off the CSP 40.

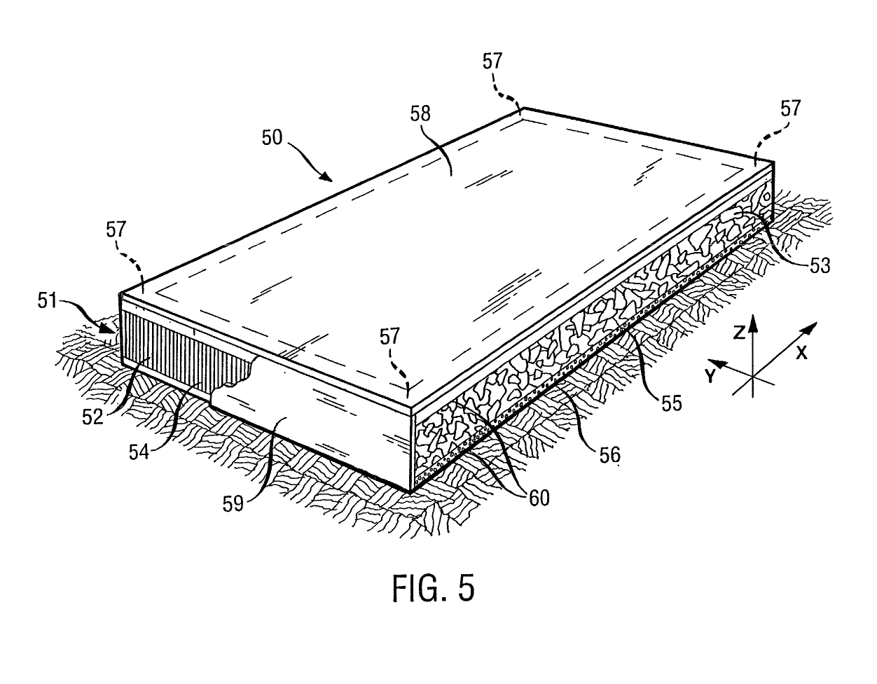

FIG. 5 illustrates a preferred embodiment of a CSP 50 that is designed for use as a road panel, crane mat, and other similar applications, where the CSP 50 is supported directly on the ground. It should be understood that several of the Composite Structural Panels 50 can be placed side-by-side to form a continuous riding surface (not shown).

The CSP 50 comprises a core 51 made of a plurality of vertically laminated OSB sheets 52. Similar to the vertically laminated test beam 30, the longitudinal or x-direction is parallel to the wide face of the CSP 50, and to the plane of the flakes 53 of the OSB sheets 52. The transverse or y-direction is perpendicular to the wide face of the OSB sheets 52, and to the plane of the flakes 53 of the OSB sheets 52. The axial or z-direction is parallel to the wide face of the OSB sheets 52, and to the plane of the flakes 53 of the OSB sheets 52.

A method of manufacturing the CSP 50 will now be described. First, the core 51 made of the plurality of OSB sheets 52 is formed by bonding a plurality of OSB sheets 52 or other similar wood composites product together under pressure. Preferably 15½ OSB sheets, each having a dimension of ¾″×4′×16′ are ripped into sixty-two OSB sheets 52 having a dimension of ¾″×1×16′ to form the core 51 of the CSP 50 having a dimension of 4″×1″×16′.

Then, an adhesive 56 is applied between the plurality of OSB sheets 52. While not a requirement of the invention, the adhesive used is preferably a PRF (Phenol Resorcinol Formaldehyde) with spread rates of 30-90 lbs per 1000 square feet of joint area. Other water-resistant wood adhesives may be used. Glueline clamping pressures ranging from about 5 psi to about 110 psi can be used. It should be appreciated that the invention is not limited by the use of an adhesive, and that the invention can be practiced by the use of any fastening means, such as bolts, and the like.

Next, the OSB sheets 52 are disposed so that the applied loading in the axial or z-direction is parallel to the wide face or plane of the individual OSB or other wood composite sheets comprising the core 51 of the CSP 50. As described later, other orientations of the individual sheets 52 with respect to the applied load in the axial or z-direction are within the scope of this invention. However, the parallel orientation of the OSB sheets 52 with respect to the applied loading is a key feature of the invention for applications where high shear stresses are present, such as for road panels, crane mats, and other similar applications.

Testing has shown that this parallel orientation of the OSB sheets 52 with respect to the applied loading in the axial or z-direction can eliminate the occurrence of in-plane or rolling shear failures. Testing has also shown that these types of failures can significantly reduce the structural load capacity of the CSP 50 and can be avoided by changing the orientation of the OSB sheets 52 with respect to the direction of the applied loading. The parallel orientation of the OSB sheets 52 with respect to applied loading increases the longitudinal shear strength of the CSP 50 from about 200 lbs/in² to about 500 lbs/in². Thus, the parallel orientation of the OSB sheets 52 with respect to the applied load causes a dramatic improvement in mechanical properties that enables more than double the shear strength of the composite core 51 when compared to other orientations with respect to the direction of the applied loading on the OSB sheets 52. This in turn significantly minimizes the size and cost of the composite core 51 and the CSP 50.

In summary, the parallel orientation of the OSB sheets 52 (and flakes) with respect to the applied load is critical when shear stresses control the design of the CSP 50, such as in road panels, crane mats, and other similar applications supported on the ground. In other applications, shear stresses may not be a limiting design factor and other orientations of the OSB sheets 52 with respect to the applied load in the axial direction 57 may be acceptable, as described later.

Next, the layer of reinforcement material 55 is applied on one or more faces of the core 51 of the CSP 50 to resist flexural tension and/or compression stresses in the x- and y-directions. For example, the layer of reinforcement material 55 is applied to the bottom face of the core 51 of the CSP 50. A preferred type of reinforcement material 55 is made of a synthetic fiber reinforcement material, such as fiberglass or carbon or aramid fibers or other fibers 56, or any combination thereof encased within any thermosetting or thermoplastic resin. Other acceptable reinforcements may be metallic plates or bars. In addition to resisting tension and/or compression stresses, the layer of reinforcement material 55 protects the core 51 from the environment and provides wear resistance. For road panel and crane mat applications, a key feature of the invention is that a substantial fraction of the fibers 56 in the layer of reinforcement material 55 run in the transverse or y-direction of the CSP 50 on the flexural tension side. As the test results for the vertically laminated beam 30 indicated, this is necessary when a parallel orientation of the OSB sheets 52 is used with respect to the direction of the applied load. In this situation, bending in the transverse direction can cause high transverse flexural tension stresses perpendicular to the plane of the strands of fiber 56 in the layer of reinforcement material 55 (x and z-directions), or in a direction perpendicular to the plane of the flakes 53 in the OSB sheets 52 (y-direction). The y-direction is the weak material axis for tension on the CSP 50.

Testing has shown that adding small fractions of reinforcement material 55 in the y-direction on the flexural tension side eliminates transverse bending failure modes and can increase the CSP 50 transverse bending MOR (Modulus of Rupture) from about 10 lbs/in² up to 200-230 lbs/in². This twenty-fold increase in transverse bending strength is possible with E-glass composite reinforcement ratios of less than 3%, and carbon fiber reinforcement ratios of less than 1%. The reinforcement ratio is defined as the area of the E-glass/resin or carbon/resin composite reinforcement divided by the area of the transverse cross-section of the CSP 50. In the laboratory testing a 50% fiber volume fraction was used. However, larger or smaller fiber volume fractions are acceptable. Therefore, a key aspect of this embodiment of the invention is the use of a layer of flexural tension reinforcement material 55 with the fibers 56 oriented in the transverse or y-direction of the CSP 50. However, it should be noted that the flexural tension reinforcement material 55 may also be oriented in the longitudinal or x-direction of the CSP 50, depending on the direction of the applied load.

In addition to the layer of transverse bending reinforcement material 55, a layer of corner/edge reinforcement material 57 (shown in phantom in FIG. 5) can be applied along the top/side edges of the core 51 of the CSP 50. Experience with field trials has shown that this layer can significantly increase the durability of the CSP 50. This is because vehicular traffic climbing onto or off the top surface of the CSP 50 can result in high stresses that may damage the edges of the CSP 50, particularly when used as road panels or crane mats. This type of reinforcement is not as critical for bridge deck applications described below, but may also be used in those applications for additional durability.

As Preferably, the layer of corner/edge reinforcement material 57 can be accomplished by applying a synthetic fiber/resin application around the corners/edges of the CSP 50. A variety of fiber types, fiber architectures and resin types may be used. A preferred fiber orientation for corner/edge reinforcement material 57 is perpendicular to the edges of the CSP 50. In other words, the fibers of the corner/edge reinforcement material 57 are oriented along the y- and z-directions for the long edges (parallel to the x-direction) of the core 51, and along the x- and z-directions 53, 57 for the short edges (parallel to the y-direction) of the CSP 50. Instead of using continuous fibers, chopped fibers or metallic reinforcement (steel or aluminum angles) may also be used.

After the layers of fiber reinforcement material 55, 57 are allowed to cure, a wearing surface 58 is applied to form one or both of the top and bottom surfaces of the CSP 50. Preferably, the wearing surface 58 is applied to form the surface which the machinery travels upon, usually the top surface of the CSP 50. Test results indicate that the wearing surface 58 can significantly extend the life of the CSP 50. Preferably, the wearing surface 58 is made of a polymer concrete material. More durability can be achieved with thicker polymer concrete overlays. Preferably, the polymer concrete consists of a mixture of sand and a thermosetting polymer. The polymer/sand ratios can vary, as well as the types of polymers and the sand composition and particle grading. Laboratory strength and durability tests of the polymer concrete/wood-composite interface were conducted to establish optimum characteristics of the polymer concrete wearing surface 58. A variety of commercial polymer concrete products were evaluated to establish their bond strength and durability to a wood composite substrate.

Based on this testing, a preferred embodiment of the invention includes a low-stiffness polymer with relatively large strains to failure (in excess of about 2%+−). The larger strains to failure and low stiffness ensure that the polymer-wood interface does not fail under hygro-thermal cycling (as measured by ASTM D2559). Other wear-resistant surfaces may also be used. For example, asphalt-impregnated membranes with an asphalt wearing surface are also possible. However, the asphalt may not be acceptable for road panels in direct contact with the ground or the groundwater in environmentally sensitive areas. In addition to being more environmentally stable than asphalt concrete, polymer concrete overlays are more resistant to water penetration, and more wear-resistant than asphalt. Field testing experience verified that a polymer concrete overlay thickness of about ¼ inch to about ½ inch is acceptable for most road panel, crane mat, and other similar applications.

The wearing surface 58 also provides good traction and skid resistance. Also, laboratory trials have shown that reinforcement material 57 on the top surface of the CSP 50 can be easily integrated within the polymer concrete wearing surface 58. Hence, the wearing surface 58 can serve as a resin encasement for the reinforcing fibers of the edge/corner reinforcement material 57.

Next, a moisture resistant treatment material 59 can be applied to the top, bottom and side surfaces of the CSP 50 in the absence of the polymer concrete wearing surface 58 and in the absence of the layer of synthetic fiber reinforcement material 55. Preferably, the moisture resistant treatment material 59 is made of a water resistant thermosetting or thermoplastic resin material. Laboratory testing, as well as an 8-month field trial on a construction site, have demonstrated that commercial polyester, vinylester and epoxy coatings provide adequate protection against moisture uptake for the CSP 50 used for road panel, crane mat, and other similar applications. Again, resin systems with low stiffness and high strains to failure provide superior long-term protection.

An optional wood preservation treatment material 60 can then be applied to the core 51 of the CSP 50 to guard against bio-degradation of the wood or wood composites core 51. The treatment may be applied to the individual wood composite sheets 52 prior to forming the core 51, or to the core 51 after it has been formed. Any commercial wood preservative treatment may be used. If a wood preservative treatment is used prior to bonding the core sheets 52, a resin compatible with the preservative treatment should be selected. An example is CCA (Chromated Copper Arsenate) preservative treatment and a PRF adhesive.

Finally, the CSP 50 may include a lifting/handling/connection device (not shown in FIG. 5), similar to the device 46 as shown in FIG. 4. It should be realized that the lifting/handling/connection device 46 is only an example and does not exclude other types of attachment devices known in the art. The CSP 50 may need to be reinforced in the vicinity of the lifting points to resist the higher static and dynamic stresses produced by lifting equipment.

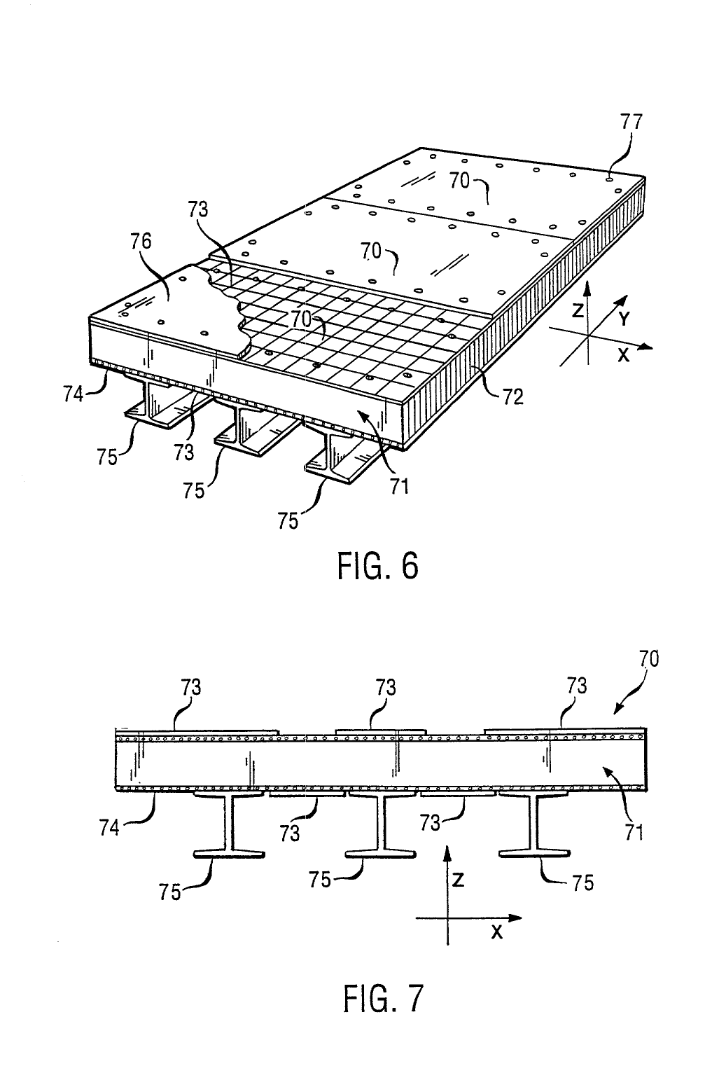

As discussed above, the CSP 50 can be used in applications in which the CSP 50 is supported directly on the ground. Referring now to FIGS. 6 and 7, there is illustrated a CSP 70 for use as a temporary or low-volume bridge deck. In this application, one or more Composite Structural Panels 70 are placed side-by-side over steel, concrete, or timber girders 75 to form a continuous riding surface. Preferably, the longitudinal axis of the girders 75 are oriented parallel to the transverse or y-direction of the CSP 70. Most of the features described earlier for the CSP 50 also apply for the CSP 70. The major difference between the CSP 50 and the CSP 70 is the types and relative magnitude of stresses to which the CSP 70 is subjected, which necessitate some changes to the reinforcement method used for the CSP 70, when compared to the CSP 50.

For bridge deck applications, the x-, y-, and z-dimensions of the CSP 70 and the thickness of reinforcement material 73 are selected to support the dead, live and impact loads required for the design. The longitudinal or x-direction of the CSP 70, otherwise known as the long direction, is preferably equal to the width of the span that must be bridged by the Composite Structural Panels 70. The transverse or y-direction of the CSP 70, otherwise known as the short dimension, can be variable. A typical length for the short dimension is between about two to six feet.

The core 71 is formed with vertically oriented OSB or plywood sheets 72 (or PSL, OSL, LSL, LVL, or glulam billets). The vertical orientation of the OSB sheets 72 is such that the plane of the flakes of the individual OSB sheets 72 is parallel to the orientation of the applied load in the z-direction. As mentioned above, this parallel orientation of the OSB sheets (and flakes) with respect to the applied load significantly increases the shear strength of the core 71.

The layer of synthetic fiber reinforcement material 73 can be applied such that the fibers 74 are oriented in the transverse or y-direction (short direction) of the CSP 70 to resist tension stresses caused by transverse or short-direction bending. In addition, a layer of synthetic fiber reinforcement material 73 may also be used in the longitudinal or x-direction (long direction) of the CSP 70 to resist long-direction bending stresses of the CSP 70. These stresses produce alternating tension and compression regions on both the top and the bottom faces of the CSP 70. The regions of tension are located over the girders 75 on the topside of the CSP 70 and at the mid-span between the girders 75 on the bottom side of the CSP 70. Testing has shown that the layer of reinforcement material 73 in the longitudinal or x-direction is only needed in the regions of high tension stresses. The layer of reinforcement material 73 may be used in regions of compression stresses, but does not add significantly to performance.

FIG. 7 shows how the layer of reinforcement material 73 with fibers 74 oriented in the longitudinal or x-direction of the CSP 70 can be optimized to coincide with the locations of maximum tension stresses. This reinforcement optimization can be accomplished if a contractor will always use the same girder spacing. Otherwise, if the CSP 70 is to be used on multiple projects with different girder spacing, the layer of reinforcement material 73 with the fibers 74 oriented along the entire longitudinal or x-direction on both the top and bottom, surfaces of the CSP 70 should be used. The layer of reinforcement material 73 with the fibers 74 oriented in the transverse or y-direction of the CSP 70 is essentially necessary on the bottom side of the CSP 70. The layer of reinforcement material 73 on the top surface of the CSP 70 is only necessary to provide additionally durability.

As described previously, a polymer concrete wearing surface 76 on the top side of the CSP 70 provides protection against moisture intrusion and offers necessary wear resistance. The CSP 70 may also include regularly spaced through-holes 77 for providing means of attachment to the supporting girders 75 and for providing means of attachment to bridge railings (not shown). It should be understood that the invention is not limited by the type of means of attaching the CSP 70 to the girders 75 and the bridge railings (not shown), and that the invention can be practiced with any suitable attachment means known in the art.

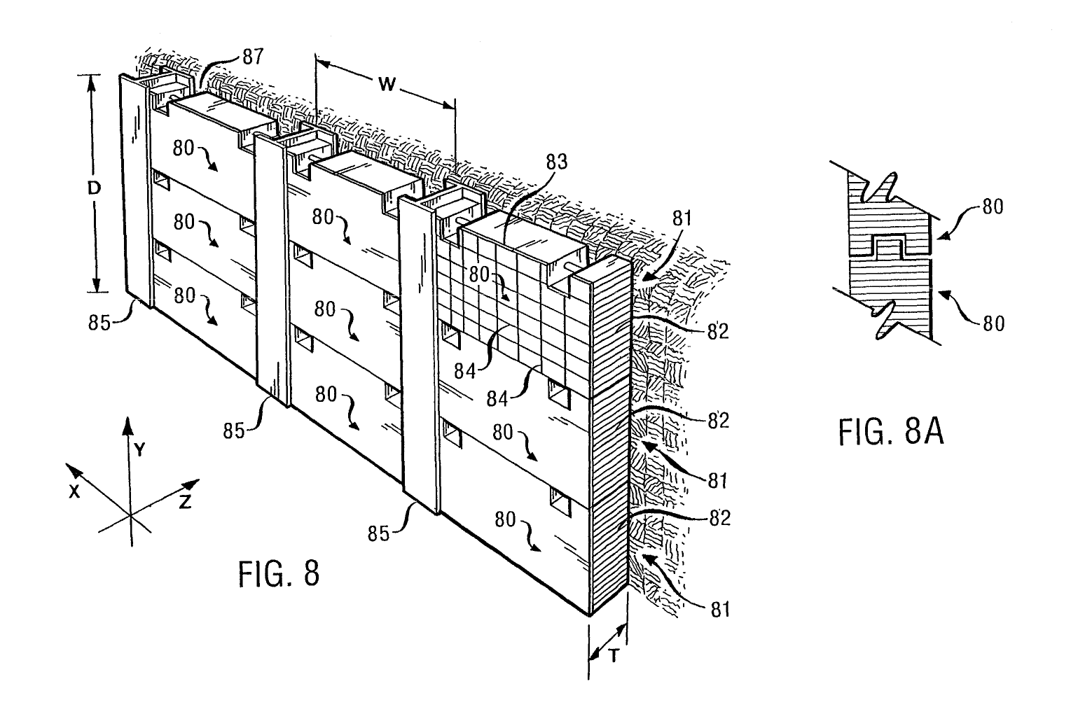

Referring now to FIG. 8, there is illustrated a CSP 80 for use as a soldier pile. Most of the features of the CSP 80 for use as a soldier pile are substantially identical for the CSP 50, 70 for the use road panel, crane mat and bridge deck applications. Some additional CSP design considerations related to soldier piles are described below.

For use as a soldier pile, the CSP 80 supports largely horizontal (z-direction) soil pressures in excavations caused by the soil and other material contained behind the excavation. The soldier pile can be formed by using one or more Composite Structural Panels 80 to span between vertically oriented I-beams 85. Instead of using the I-beams 85 to hold the Composite Structural Panels 80 together, the Composite Structural Panels 80 can be held together using a tongue-and-groove connection 86, as shown in FIG. 8a. It should be appreciated that the invention is not limited by the type of connection used to hold the Composite Structural Panels 80 together, and that the invention can be practiced by using any means of connecting the Composite Structural Panels together, several of which are well known.

Similar to the CSP 50, 70, the CSP 80 comprises a core 81 formed by a plurality of OSB or plywood sheets 82 (or PSL, OSL, LSL, LVL, or glulam billets). The orientation of the OSB sheets 82 is such that the plane of the individual OSB sheets 82 is parallel to the orientation of the applied load in the axial or z-direction. As mentioned above, this parallel orientation of the OSB sheets 82 with respect to the applied load significantly increases the shear strength of the core 81.

The thickness, T, of the CSP 80 and the thickness of fiber reinforcement 83 depend on the span or width, W, between the soldier piles, the type of material contained by the soldier pile, and the depth, D, of the excavation. That is, the CSP 80 located at a greater depth, D, is subjected to higher stresses than the CSP 80 closer to the surface of the excavation. For situations where high shear stresses exist, the individual OSB sheets 82 within the CSP core 81 are oriented parallel to the applied load, that is, in the z-direction. If shear stresses are not a design issue, the individual OSB sheets 82 within the core 81 may be perpendicular (x- or y-directions) to the applied loads, as described below.

For soldier pile applications, the layer of flexural tension reinforcement material 83 should be applied to the outside face of the CSP 80 with the fibers 84 oriented in both the x- and y-directions. In other words, the layer of reinforcement material 83 may not be needed on the face of the CSP 80 that is in direct contact with the material contained by the soldier pile. However, a layer of flexural tension reinforcement 83 on the wide faces of both the top and bottom surfaces of the CSP 80 may be used to make the CSP 80 reversible and reduce the likelihood of error of properly positioning the CSP 80 during construction.

Orienting the fibers 84 of the layer of reinforcement material 83 in the short or y-direction on the outside face of the CSP 80 is essential to provide adequate strength in short-direction bending. As discussed earlier, this layer of reinforcement material 83 is necessary when the OSB sheets 82 within the core 81 are parallel to the direction of the load. In addition, the orienting the fibers 84 of the layer of reinforcement material 83 in the long or x-direction on the outside face of the CSP 80 may be used to increase the flexural strength of the CSP 80.

The CSP 80 may include one or more lifting hooks 87 built-in to the panel to facilitate handling and construction. It should be appreciated that the invention is not limited by the use of lifting hooks 87, and that the invention can be practiced using any lifting mechanism, many of which are well known.

Connection strength between the Composite Structural Panels 80 may be enhanced by the use of a tongue-and-groove arrangement, as shown in FIG. 8a. Other arrangements for enhancing the connecting strength between the Composite Structural Panels 80 may include protruding dowels in a CSP 80 that can be disposed within holes or apertures in an adjacent CSP 80.

A polymer concrete wearing surface is not necessary in the application of the CSP 80 as a soldier pile, but may be used for added durability. The edges and corners of the CSP 80 will be subjected to impact and dynamic stresses from handling the CSP 80 and soldier wall construction operation. An additional layer of reinforcement material (not shown) around the edges/corners of the CSP 80, as described earlier for the CSP 50 for use in road panels and crane mats, may be used to increase durability of the CSP 80. Again, either synthetic fiber/resin reinforcements or metallic reinforcements may be used to reinforce the edges/corners of the CSP 80.

As before, all faces of the CSP 80 that are not coated with a fiber/resin reinforcement material 83 or a polymer concrete surface (not shown) should be protected with a layer of water-resistant sealant material (not shown). The water-resistant sealant material may be made of either thermosetting or thermoplastic resins, including asphalt.

Up to this point, the CSP cores 51, 71, 81 have been described as containing vertically laminated OSB sheets 52, 72, 82 where the sheets are oriented parallel to the direction of the applied load. In addition, the CSP cores 51, 71, 81 can be made with plywood sheets vertical or perpendicular to the applied load, or with billets of PSL, OSL, SCL, LSL, and glulam, instead of the OSB sheets 52, 72, 82.

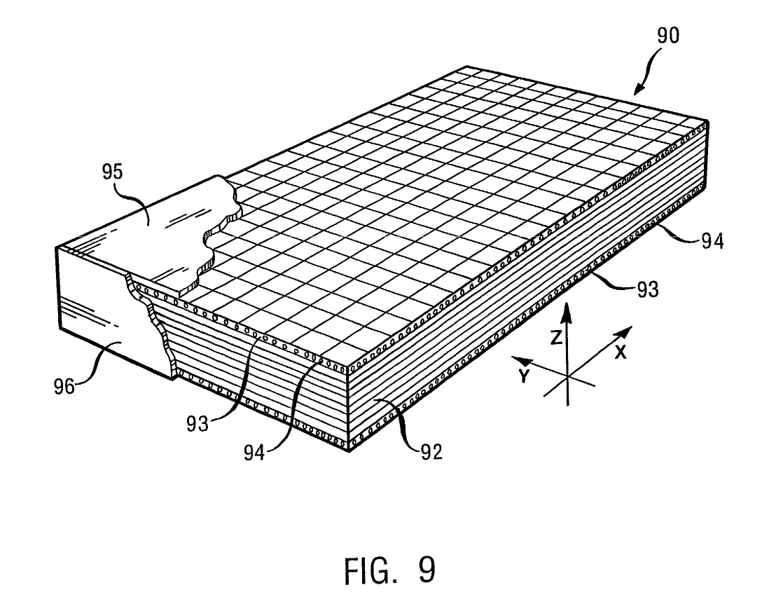

Referring now to FIG. 9, there is illustrated a CSP 90 with a core 91 comprising a single billet or multiple-bonded sheets or veneers 92 of PSL, LVL, glulam, OSL, or LSL with the wood fiber direction parallel to the longitudinal or x-direction of the CSP 90. In applications where shear stresses are not a design consideration, the laminated sheets or veneers 92 can be oriented perpendicular to the direction (z-direction) of the applied load, rather than parallel to the applied load as in the vertically laminated OSB sheets 52, 72, 82.

A layer of flexural reinforcement material 93 may be applied on one or both wide faces (top and bottom faces) of the CSP 90. The fibers 94 of the reinforcement material 93 can be oriented in both the longitudinal or x-direction and the transverse or y-direction of the CSP 90. A polymer concrete surface 95 may be applied to one or both wide faces of the CSP. A water resistant thermoset or thermoplastic coating 96 may be used on any exposed surface of the CSP 90. Lifting or handling devices (not shown) may be built into the CSP 90 in a manner similar to that disclosed in the description of the CSP 80.

Referring now to FIGS. 10-13, there is illustrated a variety of cores that may be laminated with a bonded solid-sawn skin. FIG. 10 shows a vertically laminated glulam core 100. The core 100 is preferably made of a plurality of sheets 101 of either solid-sawn softwood or hardwood or mixed softwoods and hardwoods.

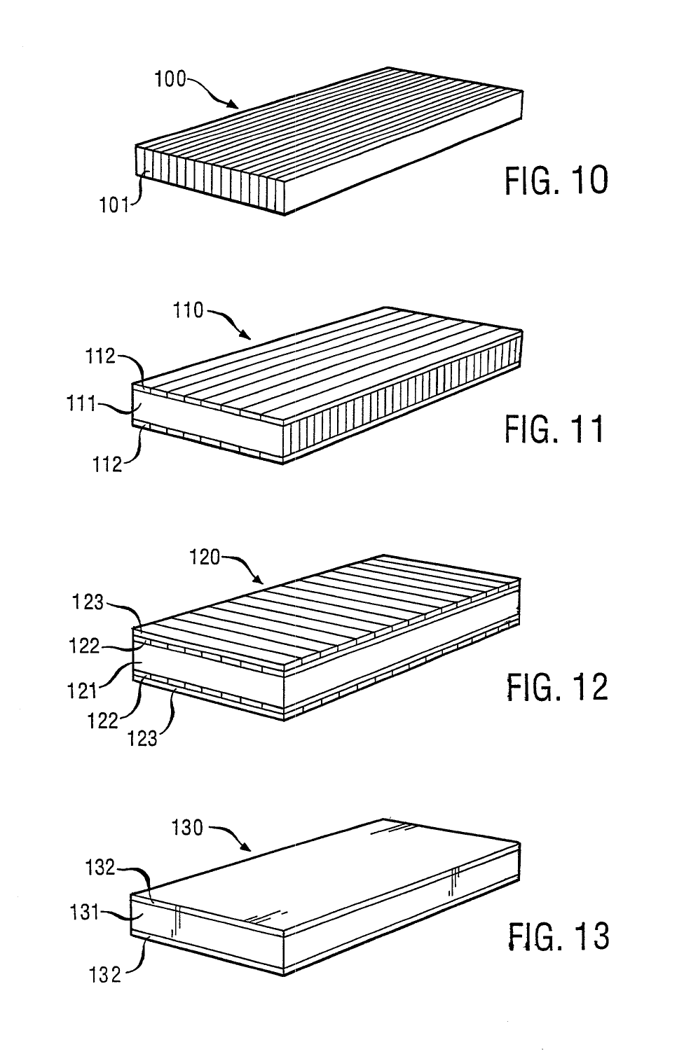

FIG. 11 shows a core 110 including a sub-core 111 with a uni-directional solid-sawn lumber sub-skin 112 made of either softwood or hardwood laminated onto the wide faces (top and bottom surfaces) of the sub-core 111 by using a water-resistant wood adhesive, such as a PRF. The thickness of the sub-skin 112 will vary depending on the stresses and the wear resistance required for the design. The sub-core 111 may comprise one or more of the following materials: end-grain balsa, vertically or horizontally laminated OSB or plywood sheets, glulam, PSL, LVL, OSL, LSL and any other SCL billet.

FIG. 12 shows a core 120 with a sub-core 121 laminated with bi-directional solid-sawn lumber sub-skins 122, 123 made of either softwoods or hardwoods. Essentially, the inner solid-sawn sub-skin 122 is laminated onto the sub-core 121 using a water-resistant wood adhesive, such as a PRF. The outer solid-sawn sub-skin 123 is laminated onto the inner sub-skin 122, but run perpendicular to the direction of the inner sub-skin 122. The thickness of the inner and outer sub-skin 122, 123 will depend on the stresses and the wear resistance required for the design. The sub-core 121 may comprise one or more of the following materials: end-grain balsa, laminated solid-sawn timbers, vertically or horizontally laminated OSB or plywood sheets, glulam, PSL, LVL, OSL, LSL, and any other SCL billet.

FIG. 13 shows a core 130 including a sub-core 131 and a single or multiple hardwood plywood or OSB or hardwood veneer sub-skin 132 laminated onto the sub-core 131 using a water-resistant wood adhesive (not shown), such as a PRF. The thickness of the sub-skin 132 varies depending on the stresses and the wear resistance required for the design. The sub-core 131 may comprise one or more of the following materials: end-grain balsa, vertically or horizontally laminated OSB or plywood sheets, glulam, PSL, LVL, OSL, LSL, and any other SCL billet.

For clarity, the wood composite cores 100, 110, 120, 130 are illustrated without any layer of reinforcement material or a wearing surface. However, the cores 100, 110, 120, 130 may include a layer of flexural reinforcement material in both the short and long directions (x- and y-direction) on one or both wide faces (top or bottom surfaces), similar to the reinforcement material disclosed for the cores 51, 71, 81. In addition, a polymer concrete surface may be applied to one or both wide faces. Also, a water resistant thermoset or thermoplastic coating (including asphalt) may be applied to any exposed surface to increase durability. Further, a coating of corner/edge reinforcement material may also be applied to the edges and corners. Lifting or handling devices may be built into the cores 100, 110, 120, 130 to facilitate handling of the CSP.

In summary, it has been demonstrated with engineering design, and with laboratory and field testing that it is possible to use a Composite Structural Panel with a composite core made of Oriented Strand Board, and other wood composite materials such as OSL, PSL, LSL, LVL, glulam and plywood, as the primarily load carrying members for road panels, crane mats, bridge decks, soldier piles, and other similar applications exposed to heavy loading and harsh environments.

The CSP of the invention removes the reliance on large timbers because the CSP is made with widely available small wood flakes, wood strands, wood veneers, or dimension lumber from either hardwood or softwood species. Its unique features include high strength and stiffness, a durable wearing surface, optional synthetic fiber reinforcement to add strength and stiffness, and an optional moisture resistant coating to increase durability. The CSP maintains the three principal advantages of conventional panel design: (1) lightweight (about 45 lbs/ft³), (2) inexpensive, and (3) chemically inert. Because of the superior durability of the CSP when compared to bolted solid-sawn timber panels, the CSP offers larger opportunities for re-use on multiple construction projects, and reduced life-cycle cost.

The use of more cost-effective material enables the CSP to be more cost-effective, particularly on a life-cycle basis, than conventional sold-sawn timber panels. Crane mats, road panels, and bridge deck panels made with hardwood timbers are currently very difficult to obtain in large quantities because they require large solid-sawn timbers, an increasingly scarce resource. The use of more readily available material reduces environmental pressures on the timber resource. Also, contractors now have difficulties acquiring these panels in reasonable quantities and short lead times. The CSP solves an increasingly acute supply problem for panels made with solid-sawn timbers and reduces contractor acquisition lead time.

It should be realized that the CSP of the invention can be designed for any load scenario, and is not limited to the applications described above. Further, it should be appreciated that the invention is not limited to a particular size or shape of the Composite Structural Panel, and that the invention can be practiced with any desirable size or shape.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A Composite Structural Panel, comprising:
a core comprising a plurality of sheets made of a composite material, the plurality of sheets having at least one wide face being oriented parallel to a direction of a load applied to the core.

2. The panel according to claim 1, further comprising a wearing surface applied to one of a top surface and a bottom surface of the core.

3. The panel according to claim 1, further comprising a layer of reinforcing material applied to one of a top surface and a bottom surface of the core.

4. The panel according to claim 3, wherein the layer of reinforcing material comprises unidirectional glass fiber reinforced polymer material.

5. The panel according to claim 4, wherein the unidirectional glass fiber reinforced polymer material is applied to the bottom surface of the core such that glass fibers within the glass fiber reinforced polymer material are oriented in a transverse direction with respect to the plurality of sheets.

6. The panel according to claim 1, further comprising an adhesive applied between the plurality of sheets.

7. The panel according to claim 1, further comprising a layer of water-resistant sealant applied to one of a top surface, a bottom surface, and side surfaces of the core.

8. The panel according to claim 1, further comprising a layer of preservative treatment material applied to one of a top surface, a bottom surface, and side surfaces of the core.

9. A method of manufacturing a composite structural panel, comprising the steps of:
forming a composite core comprising a plurality of sheets made of a composite material, the plurality of sheets having at least one wide face being oriented parallel to a direction of an applied load.

10. The method according to claim 9, further including the step of applying a layer of reinforcing material to one of a top surface and a bottom surface of the core.

11. The method according to claim 9, further including the step of applying a coating of polymer concrete to one of a top surface and a bottom surface of the core.

12. The method according to claim 9, further comprising the step of applying a layer of water-resistant sealant to one of a top surface, a bottom surface and side surfaces of the core.

13. The method according to claim 9, further comprising the step of applying an adhesive between the plurality of sheets of composite material.

14. The method according to claim 13, wherein the plurality of sheets are bonded together by applying pressure.

15. The method according to claim 9, further comprising the step of applying a layer of preservative treatment material to one of a top surface, a bottom surface and side surfaces of the core.

16. A core for a Composite Structural Panel, comprising:
a sub-core comprising a plurality of sheets of composite material; and
a sub-skin laminated to one of a top surface and a bottom surface of the sub-core.

17. The core according to claim 16, wherein at least one wide face of the plurality of sheets is oriented parallel to a direction of an applied load.
